(19) United States
(12) Patent Application Publication
(10) Pub. No.: US 2019/0190099 A1
(43) Pub. Date: Jun. 20, 2019

(54) CELL, CELL PACK, ELECTRONIC DEVICE, ELECTRIC VEHICLE, ELECTRICITY STORAGE APPARATUS, AND POWER SYSTEM

(71) Applicant: MURATA MANUFACTURING CO., LTD., Kyoto (JP)

(72) Inventors: Natsuko KATASE, Kyoto (JP); Ryosuke TAKAGI, Kyoto (JP)

(21) Appl. No.: 16/193,772

(22) Filed: Nov. 16, 2018

Related U.S. Application Data
(63) Continuation of application No. PCT/JP2017/012096, filed on Mar. 24, 2017.

(30) Foreign Application Priority Data
May 19, 2016 (JP) 2016-100507

(51) Int. Cl. H01M 10/6553; H01M 2/30; H01M 2/06; H01M 10/613; H01M 10/654; H01M 10/6551; H01M 2/02; H01M 10/647

(52) U.S. Cl. CPC H01M 10/6553; H01M 2/30; H01M 2/06; H01M 10/647; H01M 10/654; H01M 10/6551; H01M 2/021; H01M 10/613

(57) ABSTRACT

Provided is a battery including: a battery element including an electrode lead including at least one through hole; and a heat release material provided on the electrode lead between the through hole and the battery element.

### TECHNICAL FIELD

The present technology relates to a battery, a battery pack, an electronic device, an electric vehicle, an electric storage device, and an electric power system.

### BACKGROUND ART

Conventionally, various members have been proposed as cooling members for batteries. For example, a secondary battery is proposed in which a terminal part is connected to a thermally conductive bus bar cooled by a coolant (Patent Document 1). In addition, a storage battery module is proposed which releases heat with an electric heating plate sandwiched between stacked cells (Patent Document 2). Furthermore, a battery is proposed which has a heat-absorbing member provided between a current collector and an electrode terminal within a cell (Patent Document 3).

### PRIOR ART DOCUMENTS

### Patent Documents

Patent Document 1: Japanese Patent Application Laid-Open No. 2015-002105

Patent Document 2: Japanese Patent Application Laid-Open No. 2014-086281

Patent Document 3: Japanese Patent Application Laid-Open No. 2007-188747

### SUMMARY OF THE INVENTION

### Problem to be Solved by the Invention

An object of the present technology is to provide a battery, a battery pack, an electronic device, an electric vehicle, an electric storage device, and an electric power system which can prevent heat generated by an electrode lead including a through hole from being transferred to a battery element.

### Means for Solving the Problem

In order to solve the above-mentioned challenge, a first aspect of the technology is a battery including: a battery element including an electrode lead including at least one through hole; and a heat release material provided on the electrode lead between the through hole and the battery element.

### Advantageous Effect of the Invention

According to the present technology, the heat generated by the electrode lead including the through hole can be prevented from being transferred to the battery element. It is to be noted that the effects described herein are not necessarily to be considered limited, and may be any of the effects described in the specification.

### BRIEF EXPLANATION OF DRAWINGS

FIG. 1A is a perspective view illustrating a configuration example of a film exterior-type battery according to a first embodiment of the present technology.

FIG. 1B is a cross-sectional view taken along the line IB-IB of FIG. 1A.

FIG. 2 is an exploded perspective view illustrating a configuration example of a first film exterior-type battery according to an embodiment of the present technology.

FIG. 3 is an enlarged cross-sectional view illustrating a configuration example of a battery element.

FIG. 4A is a plan view illustrating a configuration example of a positive electrode current collector. FIG. 4B is a plan view illustrating a configuration example of a negative electrode current collector.

FIGS. 5A, 5B, 5C, 5D, and 5E are cross-sectional views each illustrating a configuration example of a film exterior-type battery according to a modification example of the first embodiment of the present technology.

FIG. 6 is a block diagram illustrating a configuration example of a battery pack and an electronic device according to a second embodiment of the present technology.

FIG. 7 is a schematic diagram illustrating a configuration example of an electric storage system according to a third embodiment of the present technology.

FIG. 8 is a schematic diagram illustrating a configuration of an electric vehicle according to a fourth embodiment of the present technology.

FIG. 9A is a perspective view illustrating the configuration of a positive electrode lead and a heat release material according to Test Example 1. FIG. 9B is a perspective view illustrating the configuration of a positive electrode lead according to Test Example 2.

FIG. 10 is a perspective view illustrating the configuration of a positive electrode lead and a heat release material according to Test Example 3.

### MODE FOR CARRYING OUT THE INVENTION

Hereinafter, embodiments of the present technology will be described with reference to the drawings. It is to be noted that the description will be provided in the following order.

1. First Embodiment
1.1 Battery Configuration
1.2 Method for Manufacturing Battery
1.3 Advantageous Effect
1.4 Modification Example

2. Second Embodiment

3. Third Embodiment

4. Fourth Embodiment

### 1. First Embodiment

### 1.1 Battery Configuration

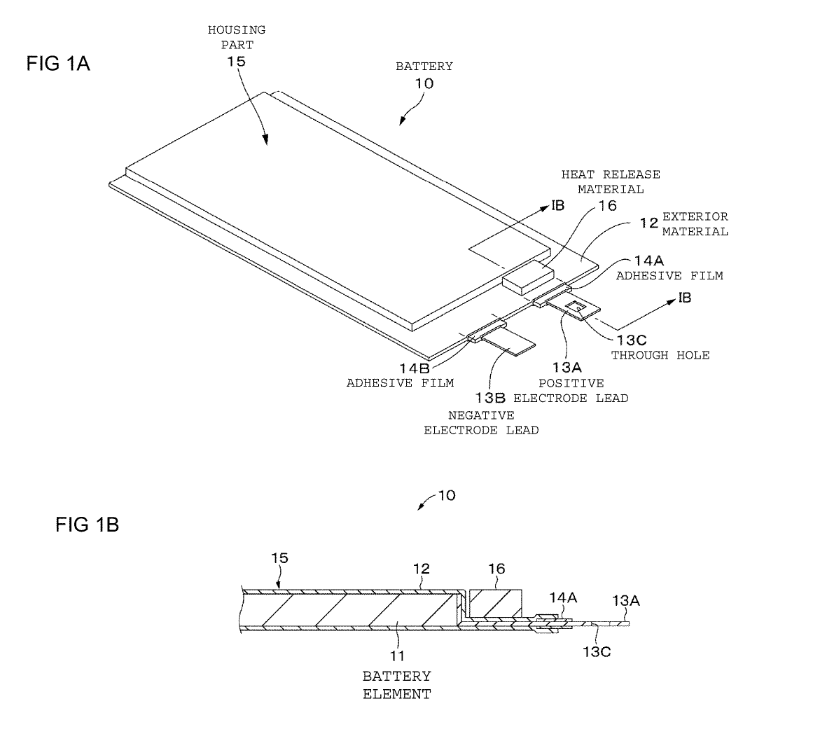

As shown in FIG. 1A, a film exterior-type battery (hereinafter referred to simply as a “battery”) 10 according to a first embodiment of the present technology is a so-called flat or rectangular lithium ion polymer battery, where a battery element 11 with a positive electrode lead 13A and a negative electrode lead 13B attached thereto is housed in a film-shaped exterior material 12, thereby allowing for the reduction in size, the reduction in weight, and the reduction in thickness.

The positive electrode lead 13A and the negative electrode lead 13B are each led out from the inside of the exterior material 12 toward the outside, for example, in the same direction. Each of the positive electrode lead 13A and the negative electrode lead 13B is made from, for example, a metal material such as aluminum (Al), copper (Cu), nickel (Ni), or stainless steel, and adapted to have the form of a thin plate or mesh. In this specification, the end side of the battery element 11 from which the positive electrode lead 13A and the negative electrode lead 13B are led out is referred to as a top side, and the end side on the side opposite to the top side is referred to as a bottom side. In addition, both end sides located between the top side and the bottom side are referred to as sides.

The positive electrode lead 13A is provided with a through hole 13C that penetrates from the one surface of the lead toward the other surface thereof on the opposite side. In the planar view of the through hole 13C from a direction perpendicular to one surface of the positive electrode lead 13A, the through hole 13C has a rectangular shape. It is to be noted that the number of through holes 13C is not limited to one, and may be two or more. In addition, the shape of the through hole 13C is not limited to any rectangular shape, but may be a circular shape, an elliptical shape, a polygonal shape other than a rectangular shape, an irregular shape, or the like.

The through hole 13C is intended to fuse the positive electrode lead 13A at the part where the through hole 13C is provided when an abnormal large current flows through the positive electrode lead 13A. Although the through hole 13C may be provided for the negative electrode lead 13B or for both of the positive electrode lead 13A and the negative electrode lead 13B, it is preferable to provide the through hole 13C at least for the positive electrode lead 13A. In general, the material used for the positive electrode lead 13A has a lower melting point than the material used for the negative electrode lead 13B. For this reason, the fusing temperature of the lead can be made lower in the case in which the through hole 13C is provided for the positive electrode lead 13A, as compared with the case in which the through hole 13C is provided for the negative electrode lead 13B, and the safety can be improved.

(Exterior Material)

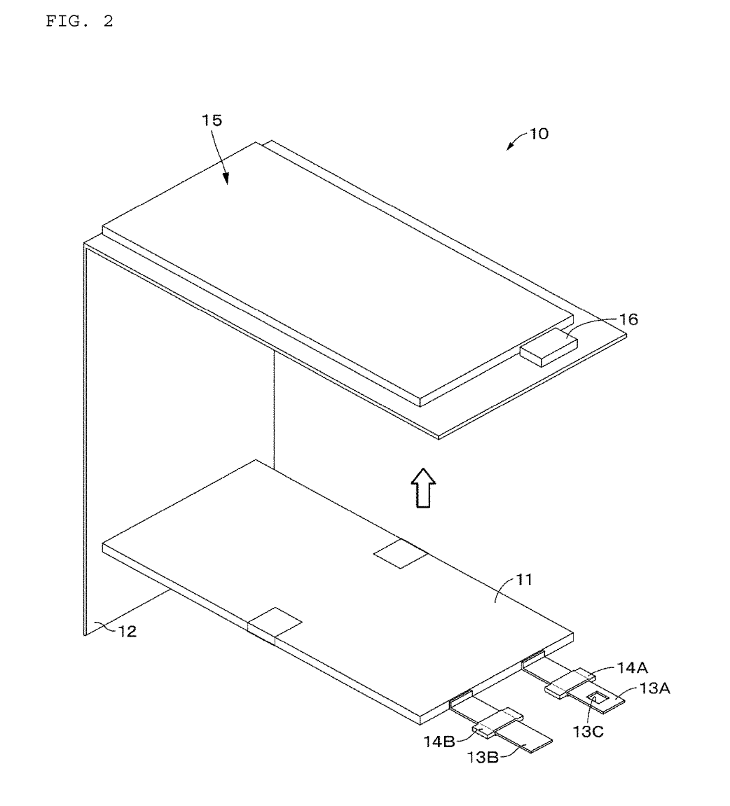

As shown in FIG. 2, the exterior example 12 has a rectangular shape, which is folded back from a center part thereof in such a way that each side is overlapped. The boundary of folding back may be provided in advance with a notch or the like. Between the folded exterior materials 12, the battery element 11 is sandwiched, and the exterior material 12 is sealed at the top side and sides of the periphery of the battery element 11. Examples of the form of the sealing include, for example, adhesive bonding such as thermal fusion bonding. The exterior material 12 has, on one surface thereof overlapped, a housing part 15 for housing the battery element 11. The housing part 15 is formed by deep drawing, for example.

The exterior material 12 is made from, for example, a laminate film that has flexibility. The exterior material 12 is configured to have, for example, a heat-sealing resin layer, a metal layer, and a surface protection layer sequentially laminated. It is to be noted that the surface on the heat-sealing resin layer side serves as the surface on which the battery element 11 is housed. Examples of the material for the heat-sealing resin layer include polypropylene (PP) and polyethylene (PE). Examples of the material for the metal layer include, for example, aluminum. Examples of the material for the surface protection layer include, for example, nylon (Ny). Specifically, for example, the exterior material 12 is composed of, for example, a rectangular aluminum laminate film with a nylon film, an aluminum foil, and a polyethylene film bonded to each other in this order. The exterior material 12 is provided, for example, such that the polyethylene film side and the battery element 11 are opposed to each other, and respective outer edges thereof are attached firmly to each other by fusion bonding or with an adhesive. An adhesive film 14A is inserted between the exterior material 12 and the positive electrode lead 13A, and an adhesive film 14B is inserted between the exterior material 12 and the negative electrode lead 13B. The adhesive films 14A, 14B are, in order to prevent the ingress of outdoor air, made from a material that has adhesiveness to the positive electrode lead 13A and the negative electrode lead 13B, for example, a polyolefin resin such as polyethylene, polypropylene, modified polyethylene, or modified polypropylene.

It is to be noted that the exterior material 12 may be composed of a laminate film that has another structure, a polymer film such as polypropylene, or a metal film, instead of the above-described laminate film. Alternatively, a laminate film may be used which has a polymer film laminated on one or both sides of an aluminum film as a core material.

In addition, from the viewpoint of aesthetic aspect, a member further including a coloring layer and/or a member with a coloring material included in at least one layer selected from a heat-sealing resin layer and a surface protection layer may be used as the exterior material 12. When an adhesive layer is provided at least one of between the heat-sealing resin layer and the metal layer and between the surface protection layer and the metal layer, the adhesive layer may be adapted to include a coloring material.

(Heat Release Material)

A heat release material 16 is provided on the outer surface of the exterior material 12, so as to be positioned between the through hole 13C formed for the positive electrode lead 13A and the top side end of the battery element 11. The heat release material 16 and the outer surface of the exterior material 12 are bonded to each other with an adhesive layer or the like interposed therebetween. The adhesive layer is made of an adhesive material such as a pressure-sensitive material. As the pressure-sensitive material, for example, an acrylic adhesive, a rubber-based adhesive, a silicon-based adhesive, or the like can be used. In this regard, pressure sensitive adhesion is defined as a type of adhesion. In accordance with this definition, the pressure-sensitive layer is regarded as a type of adhesive layer. The adhesive layer may be an adhesive material applied to both sides of a film-shaped support. Examples of the thus configured adhesive layer include a double-sided adhesive tape and a double-sided adhesive film. It is to be noted that the heat release material 16 may be pressed against the outer surface of the exterior material 12 with a holding member such as a clip, instead of bonding the heat release material 16 and the outer surface of the exterior material 12 with an adhesive layer or the like.

The heat release material 16 is intended to keep the heat generated at the part of the positive electrode lead 13A where the through hole 13C is provided from being transferred to the battery element 11 during normal use of the battery 10. Providing the heat release material 16 outside the exterior material 12 eliminates the need to change the size or the like of the battery element 11 or the exterior material 12 depending on the size of the heat release material 16, thus making it easy to manufacture the battery 10.

The heat release material 16 has the shape of a thin plate, and has a principal surface bonded to the outer surface of the exterior material 12. In the planar view of the heat release material 16 from a direction perpendicular to the principal surface of the heat release material 16, the heat release material 16 has a rectangular shape. However, the shape of the heat release material 16 is not limited to any rectangular shape, but may be a circular shape, an elliptical shape, a polygonal shape other than a rectangular shape, an irregular shape, or the like.

The heat release material 16 is made of at least one of a metal, a metal compound, carbon, and a carbon-containing resin. In this regard, the term “metal” also includes metalloid elements. As the metal compound, for example, at least one of a metal nitride, a metal carbide, a metal oxide, and the like can be used. The metal compound may be ceramics. Specific examples of the material of the heat release material 16 include aluminum (Al), copper (Cu), aluminum nitride (AlN), silicon carbide (SiC), aluminum oxide (Al₂O₃), and the like. In the case of using a conductive material such as a metal (for example, aluminum, copper) as the material of the heat release material 16, the surface of the heat release material 16 is preferably subjected to an insulating treatment.

From the viewpoint of heat release, the thermal conductivity of the heat release material 16 is preferably 30 W/m²·K or more. In this regard, the thermal conductivity has a value obtained by a laser flash method.

(Battery Element)

As shown in FIG. 2, the battery element 11 is a battery element including a stack-type electrode structure that has a flat shape. The positive electrode lead 13A and the negative electrode lead 13B are led out, for example, from one end of the battery element 11 in the same direction. The battery element 11 is a so-called lithium ion polymer secondary battery.

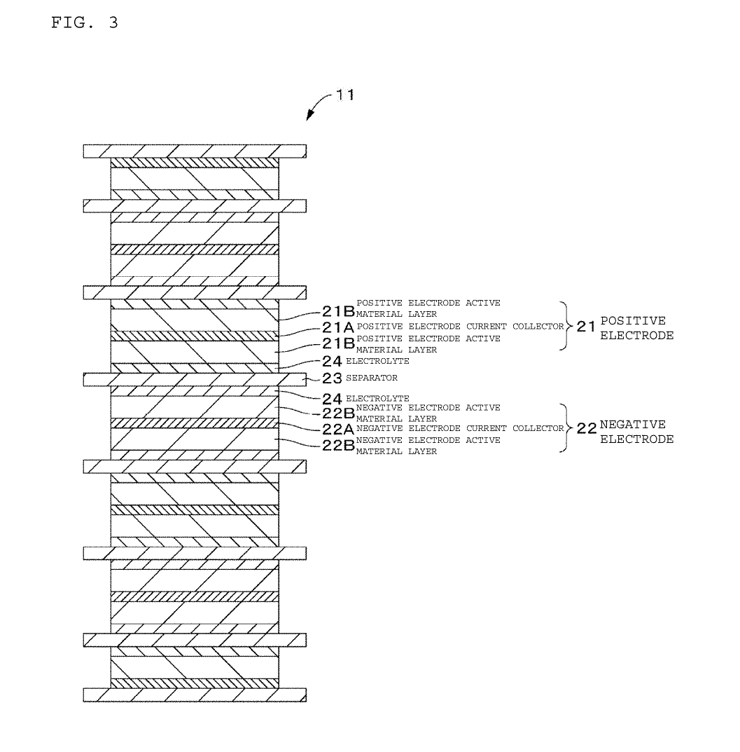

As shown in FIG. 3, the battery element 11 includes a positive electrode 21, a negative electrode 22, a separator 23, and an electrolyte layer 24, and the positive electrode 21, the negative electrode 22, and the separator 23 each have, for example, a rectangular shape. The battery element 11 has a structure including, for example, the positive electrode 21 and the negative electrode 22 stacked with the separator 23 interposed therebetween. Electrolyte layers 24 are provided respectively between the positive electrode 21 and the separator 23 and between the negative electrode 22 and the separator 23.

(Positive Electrode)

The positive electrode 21 has a structure with a positive electrode active material layer 21B provided on one or both surfaces of a positive electrode current collector 21A. It is to be noted that, although not shown, the positive electrode active material layer 21B may be provided only on one surface of the positive electrode current collector 21A. The positive electrode current collector 21A is made from, for example, metal foil such as aluminum foil, nickel foil, or stainless steel foil. The positive electrode active material layer 21B includes, for example, a positive electrode active material capable of occluding and releasing lithium which is an electrode reactant.

The positive electrode active material layer 21B may further contain an additive, if necessary. For example, at least one of a conducting agent and a binder can be used as the additive.

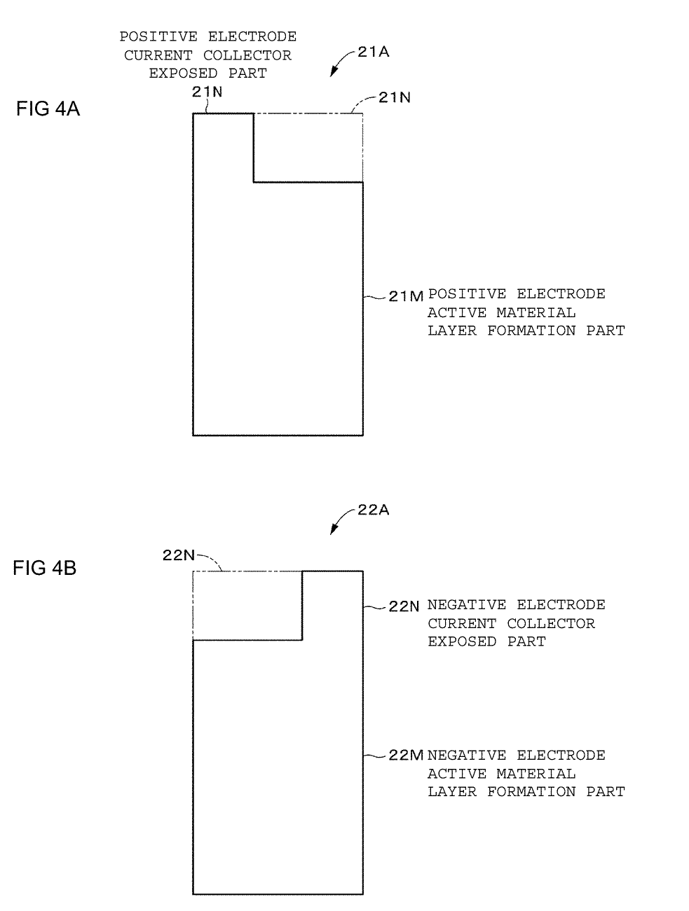

As shown in FIG. 4A, the positive electrode current collector 21A includes a positive electrode active material layer formation part 21M and a positive electrode current collector exposed part 21N. The positive electrode active material layer formation part 21M has, for example, a rectangular shape as viewed from a direction perpendicular to the principal surface of the positive electrode current collector 21A. The positive electrode active material layer 21B is provided on one or both sides of the positive electrode active material layer formation part 21M. The positive electrode current collector exposed part 21N is provided to extend from a part of one side of the positive electrode active material layer formation part 21M. However, as shown by a two-dot chain line in FIG. 4A, the positive electrode current collector exposed part 21N may be provided to extend from the entire side of the positive electrode active material layer formation part 21M, and the shape of the positive electrode current collector exposed part 21N is not to be considered particularly limited.

The positive electrode current collector exposed part 21N is provided to extend at the peripheral edge. The stacked positive electrode 21, negative electrode 22, and separator 23 have a plurality of positive electrode current collector exposed parts 21N joined to each other, and the joined positive electrode current collector exposed parts 21N are electrically connected to the positive electrode lead 13A. The positive electrode current collector 21A is made from, for example, metal foil such as aluminum foil, nickel foil, or stainless steel foil.

As the positive electrode material capable of occluding and releasing lithium, a lithium-containing compound is suitable, for example, such as a lithium oxide, a lithium phosphorus oxide, a lithium sulfide or an intercalation compound containing lithium, and two or more thereof may be used in mixture. In order to increase the energy density, a lithium-containing compound containing lithium, a transition metal element, and oxygen (O) is preferred. Examples of such a lithium-containing compound include, for example, a lithium composite oxide that has a layered rock-salt type structure as represented by the formula (A), and a lithium composite phosphate that has an olivine-type structure as represented by the formula (B). The lithium-containing compound more preferably contains at least one selected from the group consisting of cobalt (Co), nickel, manganese (Mn), and iron (Fe) as the transition metal element. Examples of such a lithium-containing compound include, for example, a lithium composite oxide that has a layered rock-salt type structure as represented by the formula (C), the formula (D) or the formula (E), a lithium composite oxide that has a spinel-type structure as represented by the formula (F), and a lithium composite phosphate that has an olivine-type structure as represented by the formula (G), and specifically, LiNi_{0.50}Co_{0.20}Mn_{0.30}O₂, LiₐCoO₂ (a≈1), Li_{b}MiO₂ (b≈1), Li_{c1}Ni_{c2}Co_{1-c2}O₂ (c1≈1, 0<c2<1), Li_{d}Mn₂O₄ (d≈1), and LiₑFePO₄ (e≈1).

LiₚNi_{(1-q-r)}Mn_{q}M1ᵣO_{(2-y)}X_{z} (A)

(In the formula (A), M1 represents at least one element selected from Group 2 to Group 15 excluding nickel and manganese. X represents at least one of Group 16 elements and Group 17 elements excluding oxygen. p, q, y and z represent values within the ranges of 0≤p≤1.5, 0≤q≤1.0, 0≤r≤1.0, −0.10≤y≤0.20, and 0≤z≤0.2.)

LiₐM2_{b}PO₄ (B)

(In the formula (B), M2 represents at least one element selected from Group 2 to Group 15 elements. a and b represent values within the ranges of 0≤a≤2.0 and 0.5≤b≤2.0.)

Li_{f}Mn_{(1-g-h)}Ni_{g}M3ₕO₍₂₋ⱼ₎Fₖ (C)

(In the formula (C), M3 represents at least one element from the group consisting of cobalt, magnesium (Mg), aluminum, boron (B), titanium (Ti), vanadium (V), chromium (Cr), iron, copper, zinc (Zn), zirconium (Zr), molybdenum (Mo), tin (Sn), calcium (Ca), strontium (Sr) and tungsten (W). f, g, h, j and k represent values within the ranges of 0.8≤f≤1.2, 0<g<0.5, 0≤h≤0.5, g+h<1, −0.1≤j≤0.2, and 0≤k≤0.1. It is to be noted that the composition of lithium varies depending on the state of charge/discharge, and the value of f represents a value in a fully discharged state.)

LiₘNi₍₁₋ₙ₎M4ₙO₍₂₋ₚ₎F_{q} (D)

(In the formula (D), M4 represents at least one from the group consisting of cobalt, manganese, magnesium, aluminum, boron, titanium, vanadium, chromium, iron, copper, zinc, molybdenum, tin, calcium, strontium and tungsten. m, n, p, and q represent values within the ranges of 0.8≤m≤1.2, 0.005≤n≤0.5, −0.1≤p≤0.2, and 0≤q≤0.1. It is to be noted that the composition of lithium varies depending on the state of charge/discharge, and the value of m represents a value in a fully discharged state.)

LiᵣCO₍₁₋ₛ₎M5ₛO₍₂₋ₜ₎Fᵤ (E)

(In the formula (E), M5 represents at least one from the group consisting of nickel, manganese, magnesium, aluminum, boron, titanium, vanadium, chromium, iron, copper, zinc, molybdenum, tin, calcium, strontium and tungsten. r, s, t and u represents values within the ranges of 0.8≤r≤1.2, 0≤s<0.5, −0.1≤t≤0.2, and 0≤u≤0.1. The composition of lithium varies depending on the state of charge/discharge, and the value of r represents the value in a fully discharged state.)

LiᵥMn_{2-w}M6_{w}OₓF_{y} (F)

(In the formula (F), M6 represents at least one from the group consisting of cobalt, nickel, magnesium, aluminum, boron, titanium, vanadium, chromium, iron, copper, zinc, molybdenum, tin, calcium, strontium and tungsten. v, w, x and y represent values within the ranges 0.9≤v≤1.1, 0≤w≤0.6, 3.7≤x≤4.1, and 0≤y≤0.1.

The composition of lithium varies depending on the state of charge/discharge, and the value of v represents the value in a fully discharged state.)

Li_{z}M7PO₄ (G)

(In the formula (G), M7 represents at least one from the group consisting of cobalt, manganese, iron, nickel, magnesium, aluminum, boron, titanium, vanadium, niobium (Nb), copper, zinc, molybdenum, calcium, strontium, tungsten and zirconium. z represents a value within the range 0.9≤z≤1.1. The composition of lithium varies depending on the state of charge/discharge, and the value of z represents the value in a fully discharged state.)

In addition to the foregoing, other examples of the positive electrode material capable of occluding and releasing lithium also include inorganic compounds containing no lithium, such as MnO₂, V₂O₅, V₆O₁₃, NiS, and MoS.

The positive electrode material capable of occluding and releasing lithium may be any other than those mentioned above. In addition, two or more of the positive electrode materials exemplified above may be mixed in arbitrary combination.

For example, at least one selected from resin materials such as polyvinylidene fluoride (PVdF), polytetrafluoroethylene (PTFE), polyacrylonitrile (PAN), polyamide (PA), styrene butadiene rubber (SBR) and carboxymethyl cellulose (CMC), and copolymers mainly of the resin materials is used as the binder.

Examples of the conducting agent include, for example, carbon materials such as graphite, carbon black, Ketjen black, a carbon nanotube, or a carbon nanofiber, and one, or two or more thereof are used in mixture. Besides the carbon materials, a metal material, a conductive polymer material, or the like may be used as long as the material has conductivity.

(Negative Electrode)

The negative electrode 22 has a structure with a negative electrode active material layer 22B provided on one or both surfaces of the negative electrode current collector 22A, which is disposed so that the negative electrode active material layer 22B and the positive electrode active material layer 21B are opposed to each other. It is to be noted that, although not shown, the negative electrode active material layer 22B may be provided only on one surface of the negative electrode current collector 22A. The negative electrode current collector 22A is made from, for example, metal foil such as copper foil, nickel foil, or stainless steel foil.

As shown in FIG. 4B, the negative electrode current collector 22A includes a negative electrode active material layer formation part 22M and a negative electrode current collector exposed part 22N. The negative electrode active material layer formation part 22M has, for example, a rectangular shape as viewed from a direction perpendicular to the principal surface of the negative electrode current collector 22A. The negative electrode active material layer 22B is provided on one or both sides of the negative electrode active material layer formation part 22M. The negative electrode current collector exposed part 22N is provided to extend from a part of one side of the negative electrode active material layer formation part 22M. However, as shown by a two-dot chain line in FIG. 4B, the negative electrode current collector exposed part 22N may be provided to extend from the entire side of the positive electrode active material layer formation part 22M, and the shape of the negative electrode current collector exposed part 22N is not to be considered particularly limited.

The stacked positive electrode 21, negative electrode 22, and separator 23 have a plurality of negative electrode current collector exposed parts 22N joined to each other, and the joined negative electrode current collector exposed parts 22N are electrically connected to the negative electrode lead 13B. The negative electrode current collector 22A is made from, for example, metal foil such as copper foil, nickel foil, or stainless steel foil.

The negative electrode active material layer 22B includes one, or two or more negative electrode active materials capable of occluding and releasing lithium. The negative electrode active material layer 22B may further contain an additive such as a binder and a conducting agent, if necessary.

Examples of the negative electrode active material include, for example, carbon materials such as non-graphitizable carbon, graphitizable carbon, graphite, pyrolytic carbon, coke, glassy carbon, a fired body of organic polymer compound, carbon fibers, or activated carbon. Among the foregoing materials, examples of the coke include pitch coke, needle coke, and petroleum coke. The fired body of organic polymer compound refers to product carbonized by firing polymer materials such as phenolic resins or furan resins at appropriate temperatures, and some of the products are classified in non-graphitizable carbon or graphitizable carbon. These carbon materials are preferred because the crystal structures produced during charging/discharging undergo little change, thereby making it possible to achieve a high charge/discharge capacity, and making it possible to achieve favorable cycle characteristics. In particular, graphite is preferred because of its large electrochemical equivalent, which allows for the achievement of a high energy density. In addition, non-graphitizable carbon is preferred because excellent cycle characteristics are achieved. Furthermore, materials that are low in charge/discharge potential, specifically materials that are close in charging/discharging potential to lithium metal, are preferred because the materials can easily achieve increases in the energy density of the battery 10.

In addition, examples of another negative electrode active material capable of increasing the capacity also include a material containing at least one of a metal element and a metalloid element as a constituent element (for example, an alloy, a compound, or a mixture). This is because the use of such a material can achieve a high energy density. In particular, the use together with a carbon material is more preferred because a high energy density can be achieved, and because excellent cycle characteristics can be achieved. It is to be noted that, in the present technology, examples of the alloy includes, in addition to alloys composed of two or more metal elements, alloys containing one or more metal elements and one or more metalloid elements. In addition, the alloy may also contain a nonmetallic element. Examples of the compositional structure include a solid solution, a eutectic (eutectic mixture), an intermetallic compound, or a mixture of two or more thereof.

Examples of such a negative electrode active material include, for example, a metal element or a metalloid element capable of forming an alloy with lithium. Specifically, the examples include magnesium, boron, aluminum, titanium, gallium (Ga), indium (In), silicon (Si), germanium (Ge), tin, lead (Pb), bismuth (Bi), cadmium (Cd), silver (Ag), zinc, hafnium (Hf), zirconium, yttrium (Y), palladium (Pd) or platinum (Pt). These may be crystalline or amorphous.

As the negative electrode active material, a material containing, as a constituent element, a metal element or a metalloid element of Group 4B in the short periodic table is preferred, and more preferred is a material containing at least one of silicon and tin as a constituent element. This is because silicon and tin are high in ability to occlude and release lithium, and thus capable of achieving a high energy density. Examples of such a negative electrode active material include: a simple substance, an alloy, or a compound of silicon; a simple substance, an alloy, or a compound of tin; and a material that at least partially has a phase of one, or two or more thereof.

Examples of the alloy of silicon include, for example, an alloy containing, as a second constituent element other than silicon, at least one from the group consisting of tin, nickel, copper, iron, cobalt, manganese, zinc, indium, silver, titanium, germanium, bismuth, antimony (Sb) and chromium. Examples of the alloy of tin include, for example, an alloy containing, as a second constituent element other than tin, at least one from the group consisting of silicon, nickel, copper, iron, cobalt, manganese, zinc, indium, silver, titanium, germanium, bismuth, antimony and chromium.

Examples of the compound of tin or the compound of silicon include, for example, a compound containing oxygen or carbon, and may contain, in addition to tin or silicon, the second constituent element described above.

Above all, as a Sn-based negative electrode active material, a SnCoC-containing material is preferred which contains cobalt, tin, and carbon as constituent elements, where the content of carbon is 9.9% by mass or more and 29.7% by mass or less, and the proportion of cobalt to the total of tin and cobalt is 30% by mass or more and 70% by mass or less. This is because in such a composition range, a high energy density can be achieved, and excellent cycle characteristics can be achieved.

This SnCoC-containing material may further contain other constituent elements, if necessary. The other constituent elements preferably include, for example, silicon, iron, nickel, chromium, indium, niobium, germanium, titanium, molybdenum, aluminum, phosphorus (P), gallium or bismuth, and the material may contain two or more thereof. This is because the capacity or cycle characteristics can be further improved.

It is to be noted that this SnCoC-containing material has a phase containing tin, cobalt, and carbon, and this phase preferably has a low crystalline or amorphous structure. In addition, in this SnCoC-containing material, the carbon as a constituent element is preferably at least partially bonded to a metal element or a metalloid element which is another constituent element. This is because, while deterioration of cycle characteristics is believed to be caused by aggregation or crystallization of tin or the like, the carbon is bonded to another element, thereby making it possible to suppress such aggregation or crystallization.

Examples of a measurement method for examining the bonding state of the element include, for example, an X-ray photoelectron spectroscopy (XPS). In accordance with XPS, the peak of the is orbit (C1s) of carbon appears at 284.5 eV, in the case of graphite, in a device calibrated in terms of energy so that the peak of the 4f orbital (Au4f) of a gold atom is obtained at 84.0 eV. In addition, in the case of surface contaminated carbon, the peak appears at 284.8 eV. In contrast, when the carbon element increases in charge density, the peak of C1s appears in a lower range than 284.5 eV, for example, when carbon is bonded to a metal element or a metalloid element. More specifically, when the peak of a synthetic wave of C1s obtained for the SnCoC-containing material appears in a lower range than 284.5 eV, the carbon included in the SnCoC-containing material is at least partially bonded to a metal element or a metalloid element as another constituent element.

It is to be noted that in the XPS measurement, for example, the peak of C1s is used for the correction of the energy axis of the spectrum. Typically, surface contaminated carbon is present on the surface, the peak of C1s of surface contaminated carbon is determined to be 284.8 eV, which is regarded as an energy reference. In the XPS measurement, the waveform of the peak of C1s is obtained in a form including the peak of the surface contaminated carbon and the peak of the carbon in the SnCoC-containing material, and thus, the analysis with the use of, for example, commercially available software separates the peak of the surface contaminated carbon from the peak of the carbon in the SnCoC-containing material. In the analysis of the waveform, the position of the main peak present on the lowest binding energy side is determined to be an energy reference (284.8 eV).

Examples of other negative electrode active materials also include, for example, a metal oxide or a polymer compound capable of occluding and releasing lithium. Examples of the metal oxide include, for example, a lithium titanium oxide containing titanium and lithium such as lithium titanate (Li₄Ti₅O₁₂), an iron oxide, a ruthenium oxide, or a molybdenum oxide. Examples of the polymer compound include, for example, polyacetylene, polyaniline, or polypyrrole.

As the binder, for example, at least one is used which is selected from resin materials such as polyvinylidene fluoride, polytetrafluoroethylene, polyacrylonitrile, polyamide, styrene butadiene rubber, and carboxymethyl cellulose, and copolymers mainly composed of the resin materials, and the like. As the conducting agent, the same carbon material as the positive electrode active material layer 21B, or the like can be used.

(Separator)

The separator 23 is intended to separate the positive electrode 21 and the negative electrode 22, thereby allowing passage of lithium ions while preventing short circuits due to the current caused by contact between the both electrodes. The separator 23 is composed of, for example, a porous membrane made from a resin such as polytetrafluoroethylene, polypropylene, or polyethylene, and may be adapted to have a structure obtained by laminating two or more of such porous membranes. Above all, a porous membrane made from polyolefin is preferred because the membrane has an excellent short circuit-prevention effect, and can make an improvement in the safety of the battery 10 by a shutdown effect. In particular, polyethylene is preferred as a material constituting the separator 23, because polyethylene can achieve the shutdown effect within a range of 100° C. or higher and 160° C. or lower, and also has excellent electrochemical stability. Besides, a material can be used which is obtained by copolymerizing or blending a chemically stable resin with polyethylene or polypropylene. Alternatively, the porous membrane may have a structure of three or more layers, where a polypropylene layer, a polyethylene layer, and a polypropylene layer are sequentially laminated.

In addition, for the separator 23, a resin layer may be provided on one or both surfaces of the porous membrane which serves as a base material. The resin layer is a porous matrix resin layer with an inorganic substance supported. Thus, oxidation resistance can be obtained, and deterioration of the separator 23 can be suppressed. For example, polyvinylidene fluoride, hexafluoropropylene (HFP), polytetrafluoroethylene or the like can be used as the matrix resin, and it is also possible to use copolymers thereof.

Examples of the inorganic substance can include a metal, a semiconductor, or oxides or nitrides thereof. For example, examples of the metal can include aluminum and titanium, and examples of the semiconductor can include silicon and boron.

In addition, the inorganic substance preferably has substantially no conductivity and a high heat capacity. This is because when the heat capacity is high, the substance is useful as a heat sink in the case of current heating, thereby making it possible to further suppress thermal runaway of the battery 10. Examples of such an inorganic substance include oxides or nitrides such as alumina (Al₂O₃), boehmite (monohydrate of alumina), talc, boron nitride (BN), aluminum nitride (AlN), titanium dioxide (TiO₂), and silicon oxide (SiOx). It is to be noted that the porous film as a base material may contain therein the above-described inorganic substance.

The particle size of the inorganic substance preferably falls within the range of 1 nm to 10 μm. If the particle size is smaller than 1 nm, the inorganic substance is difficult to obtain, and even if the substance is available, the substance is not suitable in terms of cost. If the particle size is larger than 10 μm, the distance between the electrodes is increased, thereby achieving an insufficient amount of active material in a limited space, and thus decreasing the battery capacity.

The resin layer can be formed, for example, as follows. More specifically, a slurry composed of the matrix resin, a solvent, and the inorganic substance is applied onto the base material (porous membrane), passed through a poor solvent of the matrix resin and a good solvent bath of the solvent to cause phase separation, and then dried.

(Electrolyte Layer)

The electrolyte layer 24 includes a nonaqueous electrolytic solution, and a polymer compound to serve as a holding body for holding the nonaqueous electrolytic solution, and the polymer compound is swollen by the nonaqueous electrolytic solution.

The content ratio of the polymer compound can be adjusted appropriately. In particular, in the case of adopting a gel-like electrolyte, high ionic conductivity can be achieved, and liquid leakage from the battery 10 can be prevented, which are preferable.

The nonaqueous electrolytic solution includes, for example, a solvent and an electrolyte salt. Examples of the solvent include 4-fluoro-1,3-dioxolan-2-one, ethylene carbonate, propylene carbonate, butylene carbonate, vinylene carbonate, dimethyl carbonate, diethyl carbonate, ethyl methyl carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, ethyl propionate, acetonitrile, glutaronitrile, adiponitrile, methoxyacetonitrile, 3-methoxypropylonitrile, N,N-dimethylformamide, N-methylpyrrolidinone, N-methyloxazolidinone, nitromethane, nitroethane, sulfolane, dimethyl sulfoxide, trimethyl phosphate, triethyl phosphate, ethylene sulfite, and ambient temperature molten salts such as bis(trifluoromethylsulfonyl)imide trimethylhexyl ammonium. Among the examples, the use of at least one of the group consisting of 4-fluoro-1,3-dioxolan-2-one, ethylene carbonate, propylene carbonate, vinylene carbonate, dimethyl carbonate, ethyl methyl carbonate, and ethylene sulfite in mixture is preferred because excellent charge/discharge capacity characteristics and charge/discharge cycle characteristics can be achieved. In order to improve the battery characteristics, the electrolyte layer 24 may contain known additives.

The electrolyte salt may include one, or two or more materials in mixture. Examples of the electrolyte salt include, for example, lithium hexafluorophosphate (LiPF₆), lithium bis(pentafluoroethanesulfonyl)imide (Li (C₂F5SO₂)₂N), lithium perchlorate (LiClO₄), lithium hexafluoroarsenate (LiAsF₆), lithium tetrafluoroborate (LiBF₄), lithium trifluoromethanesulfonate (LiSO₃CF₃), lithium bis(trifluoromethanesulfonyl)imide (Li(CF₃SO₂)₂N), lithium tris(trifluoromethanesulfonyl)methyl (LiC(SO₂CF₃)₃), lithium chloride (LiCl), and lithium bromide (LiBr).

Examples of the polymer compound include, for example, polyacrylonitrile, polyvinylidene fluoride, a copolymer of vinylidene fluoride and hexafluoropropylene, polytetrafluoroethylene, polyhexafluoropropylene, a polyethylene oxide, a polypropylene oxide, polyphosphazene, polysiloxane, polyvinyl acetate, polyvinyl alcohol, polymethyl methacrylate, a polyacrylic acid, a polymethacrylic acid, a styrene-butadiene rubber, a nitrile-butadiene rubber, polystyrene, or polycarbonate. In particular, from the viewpoint of electrochemical stability, polyacrylonitrile, polyvinylidene fluoride, polyhexafluoropropylene, or polyethylene oxide is preferred.

It is to be noted that the electrolyte layer 24 may include therein the same inorganic substance as described in the explanation of the resin layer for the separator 23. This is because the heat resistance can be further improved.

The battery 10 is configured as described above. For example, the battery 10 may be designed such that the open circuit voltage (that is, a battery voltage) obtained when the battery is completely charged is, for example, 2.80 V or higher and 6.00V or lower, or 3.60 V or higher and 6.00 V or lower, preferably 4.25 V or higher and 6.00 V or lower, or 4.20 V or higher and 4.50 V or lower, further preferably 4.30 V or higher and 4.55 V or lower. In the case where the open circuit voltage obtained when the battery is completely charged is made 4.25 V or higher in the battery using a layered rock salt-type lithium composite oxide or the like as a positive electrode active material, for example, as compared with a 4.20 V battery, the amount of lithium released per unit mass is increased even in the case of the same positive electrode active material, and accordingly, the amounts of the positive electrode active material and the negative electrode active material are adjusted, thereby providing a high energy density.

In the battery 10 configured as described above, on charging, for example, lithium ions are released from the positive electrode active material layer 21B, and occluded by the negative electrode active material layer 22B through the electrolytic solution. Further, on discharging, for example, lithium ions are released from the negative electrode active material layer 22B, and occluded by the positive electrode active material layer 21B through the electrolytic solution.

### 1.2 Method for Manufacturing Battery

Next, an example of a method for manufacturing the battery 10 according to the first embodiment of the present technology will be described.

(Step of Preparing Positive Electrode)

The positive electrode 21 is prepared in the following way. First, for example, a positive electrode combination is prepared by mixing a positive electrode active material, a conducting agent, and a binder, and this positive electrode combination is dispersed in a solvent such as N-methyl-2-pyrrolidone (NMP), thereby preparing a paste-like positive electrode combination slurry. Next, the positive electrode combination slurry is applied to the band-shaped positive electrode current collector 21A, and subjected to solvent drying, and to compression molding by a roll press machine or the like to form the positive electrode active material layer 21B, thereby preparing the band-shaped positive electrode 21. Next, a precursor solution including a solvent, an electrolyte salt, a polymer compound, and a mixed solvent is applied to the positive electrode 21, and the mixed solvent is volatilized to form the electrolyte layer 24. Next, the positive electrode 21 is cut into a shape corresponding to the battery element 11. It is to be noted that the electrolyte layer 24 may be formed after cutting the positive electrode 21.

(Step of Preparing Negative Electrode)

The negative electrode 22 is prepared in the following way. First, for example, a negative electrode combination is prepared by mixing a negative electrode active material and a binder, and this negative electrode combination is dispersed in a solvent such as N-methyl-2-pyrrolidone (NMP) or methyl ethyl ketone (MEK), thereby preparing a paste-like negative electrode combination slurry. Next, the negative electrode combination slurry is applied to the band-shaped negative electrode current collector 22A, and subjected to solvent drying, and to compression molding by a roll press machine or the like to form the negative electrode active material layer 22B, thereby preparing the band-shaped negative electrode 22. Next, a precursor solution including a solvent, an electrolyte salt, a polymer compound, and a mixed solvent is applied to the negative electrode 22, and the mixed solvent is volatilized to form the electrolyte layer 24. Next, the negative electrode 22 is cut into a shape corresponding to the battery element 11. It is to be noted that the electrolyte layer 24 may be formed after cutting the negative electrode 22.

(Step of Preparing Battery Element)

The battery element 11 is prepared in the following way. First, a microporous polypropylene film or the like is cut into a rectangular shape to prepare the separator 23. Next, the pluralities of positive electrode 21, negative electrode 22, and separator 23 obtained in the way described above are stacked, for example, as shown in FIG. 3, in the order of: separator 23, positive electrode 21, separator 23, negative electrode 22, separator 23, . . . , separator 23, negative electrode 22, separator, positive electrode 21, and separator 23 to prepare a battery element 11 which has a flat shape. Next, the positive electrode current collector exposed parts 21N of the plurality of stacked positive electrodes 21 are joined to each other, and the positive electrode lead 13A is electrically connected to the joined positive electrode current collector exposed parts 21N. In addition, the negative electrode current collector exposed parts 22N of the plurality of stacked negative electrodes 22 are joined to each other, and the negative electrode lead 13B is electrically connected to the joined negative electrode current collector exposed parts 22N. Examples of the connection method include, for example, ultrasonic welding, resistance welding, and soldering, and in consideration of the damage to the connection due to heat, it is preferable to use a method which is less thermally affected, such as ultrasonic melting and resistance welding.

(Sealing Step of Battery Element)

Next, after the battery element 11 is housed in the housing part 15 of the exterior material 12, the exterior material 12 is folded back from the center to overlap the exterior materials 12 with each other while sandwiching the battery element 11 between the exterior materials 12. In that regard, the adhesive films 14A, 14B are inserted between the positive electrode lead 13A and the negative electrode lead 13B, and the exterior material 12. It is to be noted that the positive electrode lead 13A and the negative electrode lead 13B may be provided in advance with the adhesive films 14A, 14B, respectively. Next, on the top side and side of the periphery of the battery element 11, the thermally fusible resin layers of the overlapped exterior materials 12 are bonded to each other by thermal fusion bonding. Thus, the battery element 11 is sealed with the exterior material 12, thereby providing the battery 10.

(Heat Press Step)

Next, if necessary, the battery 10 is molded by heat pressing. More specifically, the battery 10 is, while applying pressure thereon, heated at a higher temperature than normal temperatures. Thus, the positive electrode active material layers 21B and the negative electrode active material layers 22B can be impregnated with the electrolyte and the like constituting the electrolyte layers 24, and the adhesion between the electrolyte layers 24 and the positive electrodes 21 and the negative electrodes 22 can be enhanced. In addition, the adhesion between the positive electrode active materials and between the negative electrode active materials can be increased, thereby reducing the contact resistance of the positive electrode active materials and the negative electrode active materials.

In the way described above, the battery 10 according to the first embodiment of the present technology is manufactured.

### 1.3 Advantageous Effect

According to the present technology, the temperature rise of the positive electrode lead 13A with the through hole 13C attached thereto can be suppressed by the heat release material 16 without providing any massive device, and damage caused by the transfer of heat to the battery element 11 can be thus reduced. In addition, attaching the heat release material 16 to the outside of the exterior material 12 simplifies the attachment and detachment, and then makes it possible to change the size of the heat release material 16 easily depending on the size of the through hole 13C, and makes it possible to simplify the manufacturing process. More specifically, the use of the present technology makes it possible to stop the battery 10 safely by fusing the positive electrode lead 13A when an abnormally large current flows, without decreasing the characteristics of the battery 10, and makes it possible to easily alleviate the influence of the temperature rise due to the through hole 13C in the normal range of use.

In addition, unlike the technique described in Patent Document 1, the unit cells undergo no increase in size for the flow of a refrigerant in order to cool the terminal parts with the refrigerant. In addition, unlike the technique described in Patent Document 2, heat generated at the terminal is not transferred to the unit cells and then released, thereby thermally affecting the unit cells.

### 1.4. Modification Example

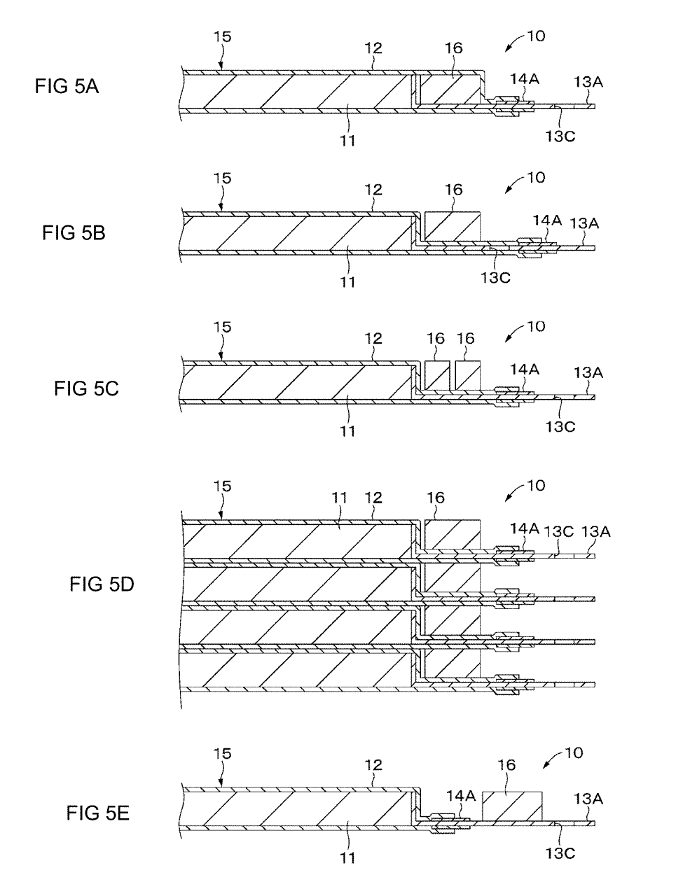

As shown in FIG. 5A, the heat release material 16 may be provided within the exterior material 12, and brought into direct contact with the positive electrode lead 13A. It is preferable to bring the heat release material 16 into direct contact with the positive electrode lead 13A as just described, from the viewpoint of heat release.

As shown in FIG. 5B, the through hole 13C may be located within the exterior material 12. In this case, the part of the positive electrode lead 13A provided with the through hole 13C can be protected, thereby keeping the positive electrode lead 13A from being cut due to an external force or the like. However, from the viewpoint of heat release, the through hole 13C is preferably provided outside the exterior material 12 as in the first embodiment.

As shown in FIG. 5C, two or more heat release materials 16 may be provided, rather than one.

In this case, the respective heat release materials 16 may differ in thermal conductivity, and the respective heat release materials 16 may differ in size.

As shown in FIG. 5D, a plurality of batteries 10 each provided with the heat release material 16 may be stacked on one another.

In this case, the periphery of the plurality of stacked batteries 10 may be supported and integrated by a support member (not shown). In addition, the heat release material 16 may support the sealed part of the exterior material 12 provided thereon at the top side. Furthermore, the positive electrode lead 13A and the negative electrode lead 13B may be both provided with the heat release material 16.

Further, in the structures shown in FIGS. 5B to 5D, the heat release material 16 may be provided within the exterior material 12, and brought into direct contact with the positive electrode lead 13A.

As shown in FIG. 5E, the heat release material 16 may be provided directly on the positive electrode lead 13A, so as to be located between the through hole 13C and the periphery of the exterior material 16.

It is preferable to bring the heat release material 16 into direct contact with the positive electrode lead 13A as just described, from the viewpoint of heat release. Further, also in the structures shown 5C and 5D, the heat release material 16 may be provided directly on the positive electrode lead 13A, so as to be located between the through hole 13C and the periphery of the exterior material 16.

In the first embodiment, although the case in which the battery 10 is flat or rectangular has been described as an example, the shape of the battery 10 is not to be considered limited to the example, and the battery 10 may have a curved shape, a bent shape, or the like.

In the first embodiment, although the rigid battery has been described as an example, a flexible battery may be adopted. Examples of the flexible battery include batteries mounted in wearable terminals such as a smartwatch, a head mound display, and iGlass (registered trademark).

In the first embodiment, although the case in which the battery element 11 has a stack-type electrode structure has been described as an example, the configuration of the battery element 11 is not to be considered limited to the example. For example, the battery element 11 may have a wound electrode structure, or a structure in which a positive electrode and a negative electrode are folded with a separator interposed therebetween, or the like.

In the first embodiment, although the configuration has been described as an example in which the positive electrode lead 13A and the negative electrode lead 13B are led out in the same direction from the same side of the exterior material 12, the configuration with the positive electrode lead 13A and the negative electrode lead 13B is not to be considered limited to the example. For example, the positive electrode lead 13A and the negative electrode lead 13B may be led out in different directions from different sides of the exterior material 12.

The through hole 13C may be provided only in the positive electrode lead 13A or in the negative electrode lead 13B, or provided in both the positive electrode lead 13A and the negative electrode lead 13B. In the case of providing the through hole 13C in the negative electrode lead 13B, there is a need to provide the heat release material 16 so as to be located between the through hole 13C of the negative electrode lead 13B and the battery element 11.

The heat release material 16 may be changed in size depending on the type of material to be used. For example, in the case of using a material which is lower in thermal conductivity, it is advisable to make the size of the material larger than a material which is higher in thermal conductivity.

In the first embodiment, although the case has been described as an example in which the electrolyte includes the nonaqueous electrolytic solution and the polymer compound to serve as a holding body for holding the nonaqueous electrolytic solution, the electrolyte may be a liquid electrolyte, that is, an electrolytic solution.

In the first embodiment, an example of applying the present technology to a lithium ion secondary battery has been presented, and the present technology is also applicable to various secondary batteries other than lithium ion secondary batteries. In addition, the present technology is not to be considered limited to any secondary battery, but it is also possible to apply the technology to primary batteries, and it is also possible to apply the technology to all-solid batteries.

### 2. Second Embodiment

### Configuration of Battery Pack and Electronic Device

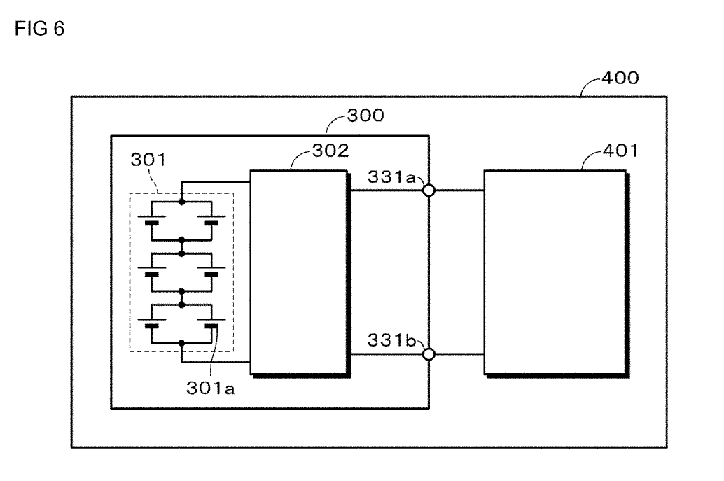

A configuration example of a battery pack 300 and an electronic device 400 according to the second embodiment of the present technology will be described below with reference to FIG. 6. The electronic device 400 includes an electronic circuit 401 of an electronic device main body, and the battery pack 300. The battery pack 300 is electrically connected to the electronic circuit 401 via a positive electrode terminal 331a and a negative electrode terminal 331b. The electronic device 400 has, for example, a configuration that allows the user to attach/detach the battery pack 300. It is to be noted that the configuration of the electronic device 400 is not limited thereto, and the battery pack 300 may be configured to be built in the electronic device 400 so that the user is not allowed to remove the battery pack 300 from the electronic device 400.

In the case of charging the battery pack 300, the positive electrode terminal 331a and negative electrode terminal 331b of the battery pack 300 are connected to a positive electrode terminal and a negative electrode terminal of a charger (not shown), respectively. On the other hand, in the case of discharging the battery pack 300 (in the case of using the electronic device 400), the positive electrode terminal 331a and negative electrode terminal 331b of the battery pack 300 are connected to a positive electrode terminal and a negative electrode terminal of the electronic circuit 401, respectively.

Examples of the electronic device 400 include, but are not limited to, notebook personal computers, tablet computers, mobile phones (for example, smartphones), personal digital assistants (Personal Digital Assistants: PDA), display devices (LCD, EL displays, electronic papers, etc.), imaging devices (for example, digital still cameras, digital video cameras, etc.), audio instruments (for example, portable audio players), game machines, cordless phone handsets, electronic books, electronic dictionaries, radios, headphones, navigation systems, memory cards, pacemakers, hearing aids, electric tools, electric shavers, refrigerators, air conditioners, television receivers, stereos, water heaters, microwave ovens, dishwashers, washing machines, driers, lighting devices, toys, medical devices, robots, road conditioners, and traffic lights.

(Electronic Circuit)

The electronic circuit 401 includes, for example, a CPU, a peripheral logic unit, an interface unit, a storage unit, and the like, and controls the overall electronic device 400.

(Battery Pack)

The battery pack 300 includes an assembled battery 301 and a charge/discharge circuit 302. The assembled battery 301 is configured to have a plurality of secondary batteries 301a connected in series and/or in parallel. The plurality of secondary batteries 301a are connected so as to arrange, for example, n batteries in parallel and m batteries in serial (n and m are positive integers). It is to be noted that FIG. 6 shows therein an example where six secondary batteries 301a are connected so as to arrange two batteries in parallel and three batteries in series (2P3S). The battery according to the first embodiment or the modified example thereof is used as the secondary battery 301a.

The charge/discharge circuit 302 is a control unit that controls charging/discharging the assembled battery 301. Specifically, in the case of charging, the charge/discharge circuit 302 controls charging the assembled battery 301. On the other hand, in the case of discharging (that is, in the case of using the electronic device 400), the charge/discharge circuit 302 controls discharging the electronic device 400.

### Modification Example

In the second embodiment described above, although the case has been described as an example where the battery pack 300 includes the assembled battery 301 composed of the plurality of secondary batteries 301a, a configuration may be adopted where the battery pack 300 includes a single secondary battery 301a in place of the assembled battery 301.

### 3. Third Embodiment

In the third embodiment, an electric storage system including the battery 10 according to the first embodiment or the modified example thereof in an electric storage device will be described. This electric storage system may be any system, including mere electric power devices, so long as the system is intended to use generally electric power. This electric power system includes, for example, a smart grid, a home energy management system (HEMS), and a vehicle, which are also capable of electricity storage.

[Configuration of Electric Storage System]

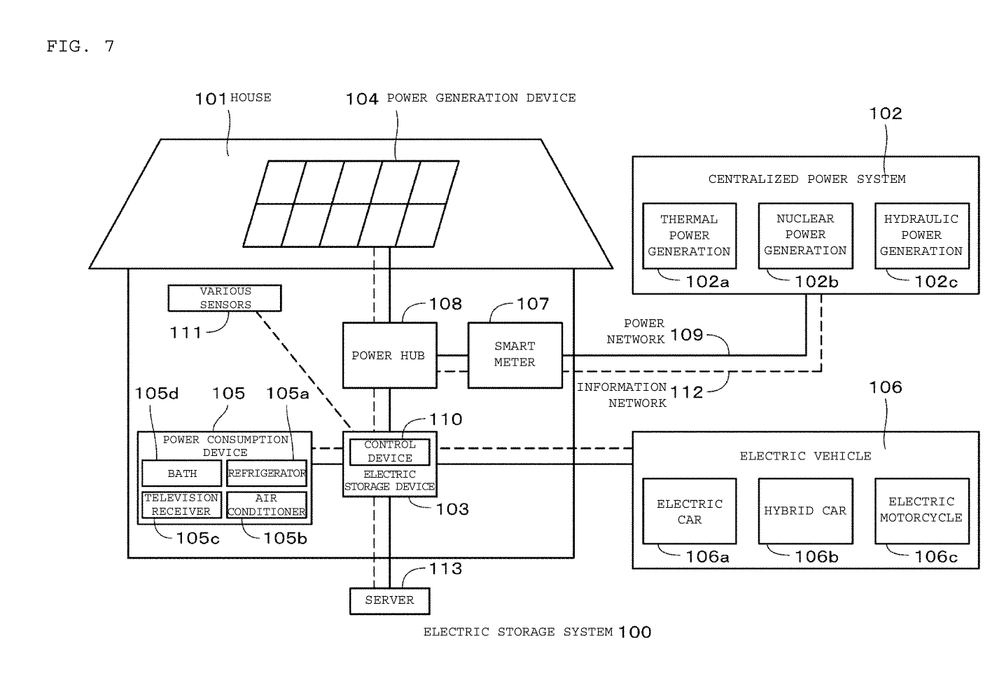

A configuration example of an electric storage system (electric power system) 100 according to the third embodiment will be described below with reference to FIG. 7. This electric storage system 100 is an electric storage system for residential use, where electric power is supplied to an electric storage device 103 via a power network 109, an information network 112, a smart meter 107, a power hub 108, and the like, from a centralized power system 102 such as a thermal power generation 102a, a nuclear power generation 102b, and a hydraulic power generation 102c. At the same time, electric power is supplied to the electric storage device 103 from an independent power source such as a home power generation device 104. The electric power supplied to the electric storage device 103 is stored. Electric power for use in a house 101 is supplied through the use of the electric storage device 103. The same electric storage system can be used not only for the house 101 but also for buildings.

The house 101 is provided with the home power generation device 104, a power consumption device 105, the electric storage device 103, a control device 110 for controlling the respective devices, the smart meter 107, the power hub 108, and sensors 111 for acquiring various types of information. The respective devices are connected by the power network 109 and the information network 112. As the home power generation device 104, a solar cell, a fuel cell, or the like is used, and electric power generated is supplied to the power consumption device 105 and/or the electric storage device 103. The power consumption device 105 refers to a refrigerator 105a, an air conditioner 105b, a television receiver 105c, a bath 105d, and the like. Furthermore, the power consumption device 105 includes an electric vehicle 106. The electric vehicle 106 refers to an electric car 106a, a hybrid car 106b, an electric motorcycle 106c, and the like.

The electric storage device 103 includes the battery according to the first embodiment or the modification example thereof. The smart meter 107 has the function of measuring the commercial power usage and transmitting the measured usage to the electric power company. The power network 109 may be any one or combination of direct-current power feeding, alternate-current power feed, and contactless power feeding.

The various sensors 111 are, for example, a human sensor, an illuminance sensor, an object detection sensor, a power consumption sensor, a vibration sensor, a contact sensor, a temperature sensor, an infrared sensor, and the like. Information acquired by the various sensors 111 is transmitted to the control device 110. With the information from the sensor 111, weather condition, the human condition, etc. can be grasped to control the power consumption device 105 automatically, and thus minimize the energy consumption. Furthermore, the control device 110 can transmit information on the house 101 to an external electric power company or the like via the Internet.

The power hub 108 performs processing such as power line branching and DC/AC conversion. Examples of the communication method of the information network 112 connected to the control device 110 include a method of using a communication interface such as a UART (Universal Asynchronous Receiver-Transceiver: transmission/reception circuit for asynchronous serial communication), and a method of using a sensor network in accordance with a wireless communication standard, such as Bluetooth (registered trademark), ZigBee, and Wi-Fi. The Bluetooth (registered trademark) system, which is applied to multimedia communication, can perform one-to-many connection communication. The ZigBee uses the physical layer of the IEEE (Institute of Electrical and Electronics Engineers) 802.15.4. The IEEE 802.15.4 is a name of a short range wireless network standard referred to as PAN (Personal Area Network) or W (Wireless) PAN.

The control device 110 is connected to an external server 113. This server 113 may be managed by any of the house 101, an electric power company, or a service provider. The information transmitted and received by the server 113 is, for example, power consumption information, life pattern information, power charges, weather information, natural disaster information, and information on electric power trade. These pieces of information may be transmitted and received from a power consumption device (for example, a television receiver) in the home, and may be transmitted and received from a device outside the home (for example, a mobile phone). These pieces of information may be displayed on a device that has a display function, for example, a television receiver, a mobile phone, a PDA (Personal Digital Assistants), or the like.

The control device 110 that controls each unit is composed of a CPU (Central Processing Unit), a RAM (Random Access Memory), a ROM (Read Only Memory), and the like, and is stored in the electric storage device 103 in this example. The control device 110 is connected to the electric storage device 103, the home power generation device 104, the power consumption device 105, the various sensors 111, the server 113 via the information network 112, and has the function of regulating, for example, the commercial power usage and the power generation. Further, the device may have a function of handling a power trade in the power market, for example.

As described above, the electric storage device 103 can store therein electric power generated not only by the centralized power system 102 such as the thermal power generation 102a, the nuclear power generation 102b, and the hydraulic power generation 102c, but also by the home power generation device 104 (solar power generation, wind power generation). Therefore, even if the home power generation device 104 fluctuates in generated power, it is possible to achieve control such as making the amount of power sent to the outside constant or discharging the power as needed. For example, the system can be also used such that electric power obtained by solar power generation is stored in the electric storage device 103, and at night, night-time power at a lower rate is stored in the electric storage device 103, and then, the power stored by the electric storage device 103 is discharged and used in the daytime at a higher rate.

It is to be noted that while an example of the control device 110 stored in the electric storage device 103 has been described in this example, the control device 110 may be stored in the smart meter 107, or may be configured alone. Furthermore, the electric storage system 100 may be used for multiple homes in multiple dwelling houses, or may be used for multiple detached houses.

### 4. Fourth Embodiment

In the fourth embodiment, an electric vehicle including the battery 10 according to the first embodiment or the modification thereof will be described.

[Configuration of Electric Vehicle]

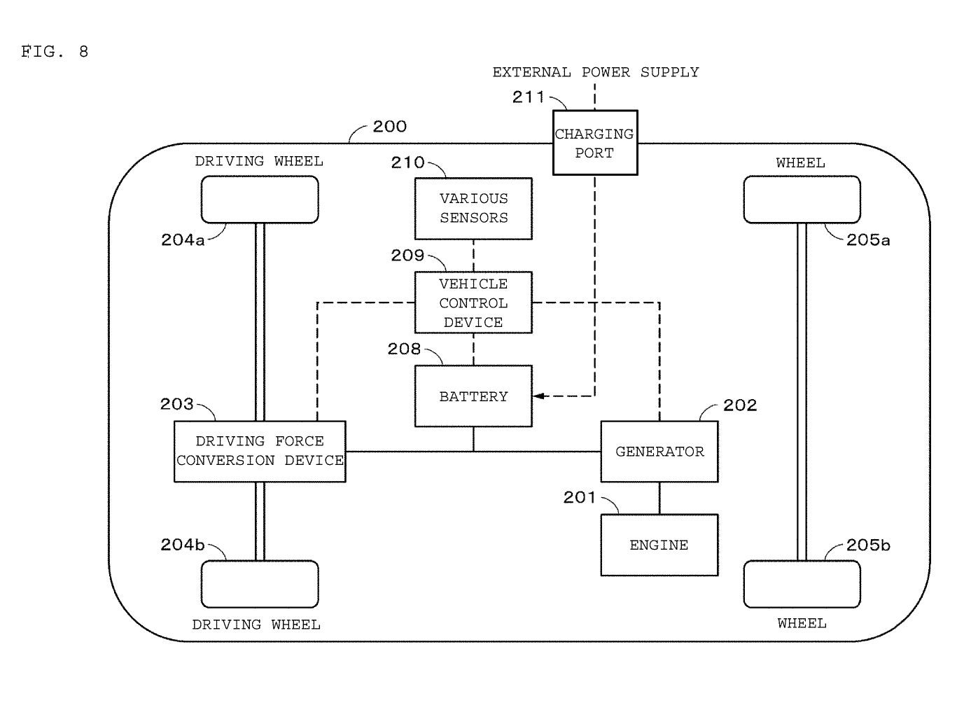

A configuration of an electric vehicle according to the fourth embodiment of the present technology will be described with reference to FIG. 8. This hybrid vehicle 200 is a hybrid vehicle that employs a series hybrid system. The series hybrid system is intended for a vehicle that runs on an electric power-driving force conversion device 203, with the use of electric power generated by a generator driven by an engine, or the electric power stored once in the battery.

The hybrid vehicle 200 carries an engine 201, a generator 202, the electric power-driving force conversion device 203, a driving wheel 204a, a driving wheel 204b, a wheel 205a, a wheel 205b, a battery 208, a vehicle control device 209, various sensors 210, and a charging port 211. The battery 10 according to the first embodiment or the modified example thereof is used as the battery 208.

The hybrid vehicle 200 travels with the electric power-driving force conversion device 203 as a power source. An example of the electric power-driving force conversion device 203 is a motor. The electric power-driving force conversion device 203 is operated by the electric power of the battery 208, and the torque of the electric power-driving force conversion device 203 is transmitted to the driving wheels 204a and 204b. It is to be noted that the electric power-driving force conversion device 203 can be applied to both an alternate-current motor and a direct-current motor by using direct current-alternate current (DC-AC) or reverse conversion (AC-DC conversion) in a required location. The various sensors 210 control the engine rotation speed via the vehicle control device 209, and control the position (throttle position) of a throttle valve, not shown. The various sensors 210 include a speed sensor, an acceleration sensor, an engine rotation speed sensor, and the like.

The torque of the engine 201 is transmitted to the generator 202, and the torque makes it possible to reserve, in the battery 208, the electric power generated by the generator 202.

When the hybrid vehicle 200 is decelerated by a braking mechanism, not shown, the resistance force during the deceleration is applied as torque to the electric power-driving force conversion device 203, and the regenerative electric power generated by the electric power-driving force conversion device 203 is reserved in the battery 208 by the torque.

The battery 208 is connected to a power source outside the hybrid vehicle 200 via the charging port 211, thereby making it also possible to receive electric power supply from the external power supply with the charging port 211 as an input port, and then reserve the received power.

Although not shown, the vehicle may be provided with an information processing device that performs information processing related to vehicle control, based on information on the battery. Examples of such an information processing device include, for example, an information processing device that displays the remaining battery level, based on information on the remaining level of the battery.

It is to be noted that as an example, the series hybrid vehicle has been described above, which runs on the motor with the use of the electric power generated by the generator driven by the engine, or the electric power stored once in the battery. However, the present technology can be also effectively applied to parallel hybrid vehicles which use the outputs of both an engine and a motor as a driving source, and appropriately switch three systems of running on only the engine, running on only the motor, and running on the engine and the motor. Furthermore, the present technology can be also effectively applied to so-called electric vehicles that run on driving by only a driving motor without using any engine.

### TEST EXAMPLES

Hereinafter, although the present technology will be specifically described with reference to test examples, the present technology is not to be considered limited to only these test examples.

The effect of the heat release material 16 was examined through a simulation for the battery 10 configured to bring the positive electrode lead 13A and the heat release material 16 into direct contact with each other.

### Test Example 1

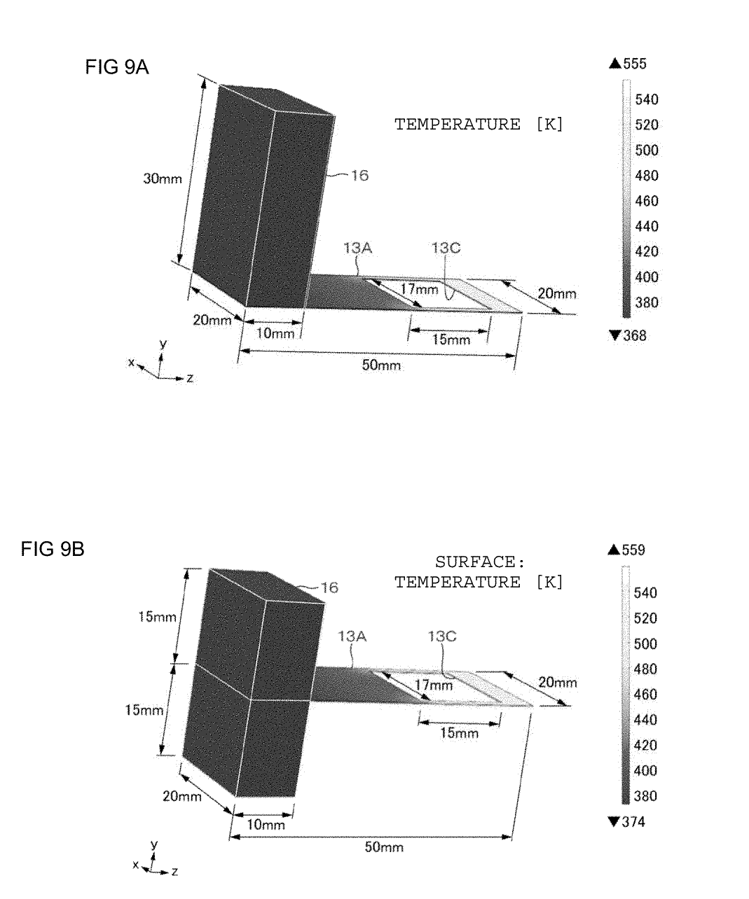

A configuration obtained by bringing the heat release material 16 into direct contact with one side of the positive electrode lead 13A was set as a model for the simulation of temperature distribution. As the simulation, a finite element method was used. The result is shown in FIG. 9A.

Here are conditions for the simulation of temperature distribution:

Current Density (50 [A]/Cross-sectional Area [m] of Positive Electrode Lead 13 A): 1.6667×10⁷ A/m²

Width of Positive Electrode Lead 13A: 20 mm

Length of Positive Electrode Lead 13A: 50 mm

Thickness of Positive Electrode Lead 13A: 150 μm

Heat Transfer Coefficient of Positive Electrode Lead 13A: 10 W/(m²K)

Electrical Resistivity of Positive Electrode Lead 13A: 2.65×10⁻¹¹Ω·m

Width of Through Hole 13C: 17 mm

Length of Through Hole 13C: 15 mm

Type of Heat Release Material 16: copper (Cu)

Height of Heat Release Material 16: 10 mm

Width of Heat Release Material 16: 20 mm

Thickness of Heat Release Material 16: 30 mm

In a case in which the heat release material 16 is brought into direct contact with one side of the positive electrode lead 13A, it has been determined that the temperature on the front side (the side provided with the through hole 13C) of the positive electrode lead 13A reaches approximately 281° C., while the temperature on the rear side (the side connected to the battery element 11) of the positive electrode lead 13A and the heat release material 16 are kept down to approximately 95° C. It is to be noted that in FIG. 9A, the temperature distribution is expressed in terms of Kelvin [K].

### Test Example 2

The simulation of temperature distribution was run by the finite element method in the same manner as in Test Example 1, except that the heat release material 16 was brought into direct contact with each of one and the other sides of the positive electrode lead 13A. The result is shown in FIG. 9B.

It is to be noted that the heat release material 16 was configured as follows:

Type of Heat Release Material 16: aluminum (Al)

Height of Heat Release Material 16: 10 mm

Width of Heat Release Material 16: 20 mm

Thickness of Heat Release Material 16: 15 mm

In a case in which the heat release material 16 is brought into direct contact with one side of the positive electrode lead 13A, it has been determined that the temperature on the front side (the side provided with the through hole 13C) of the positive electrode lead 13A reaches approximately 286° C., while the temperature on the rear side (the side connected to the battery element 11) of the positive electrode lead 13A and the heat release material 16 are kept down to approximately 100° C.

As just described, it has been determined providing the heat release material 16 makes it possible to lower the temperature on the side of the positive electrode lead 13A connected to the battery element 11, thereby preventing the high-temperature heat generated by the positive electrode lead 13A from being transferred to the battery element 11.

### Test Example 3

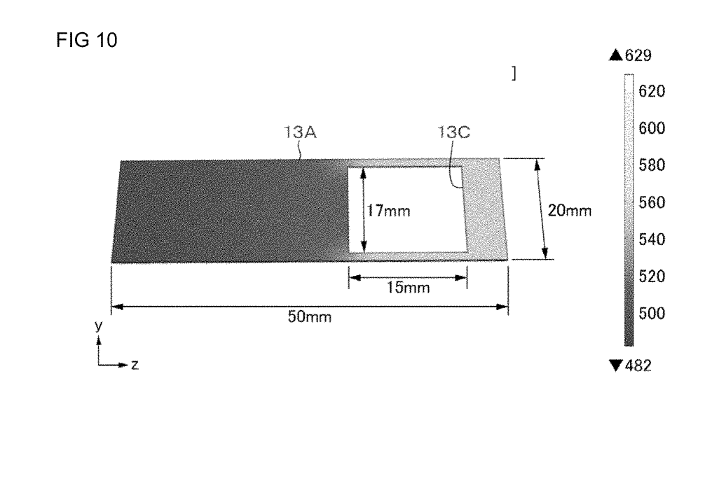

The simulation of temperature distribution was run by the finite element method in the same manner as in Test Example 1, except that the heat release material 16 was not provided. The result is shown in FIG. 10.

In a case in which the heat release material 16 is not provided, it has been determined that the temperature on the front side (the side provided with the through hole 13C) of the positive electrode lead 13A reaches approximately 355° C., whereas the temperature on the rear side (the side connected to the battery element 11) of the positive electrode lead 13A reaches approximately 209° C.

While the embodiments and test examples of the present technology have been concretely described above, the present technology is not to be considered limited to the embodiments and test examples described above, and it is possible to make various modifications based on technical idea of the present technology.

For example, the configurations, methods, steps, shapes, materials, numerical values, and the like cited in the above-described embodiments and test examples are considered by way of example only, and configurations, methods, steps, shapes, materials, and numerical values may be used which are different from the foregoing, if necessary.

Further, the configurations, methods, steps, shapes, materials, numerical values, and the like in the above-described embodiments and the test examples can be combined with each other, without departing from the scope of the present technology.

Further, the present technology can adopt the following configurations.

(1)

A battery including:

a battery element including an electrode lead including at least one through hole; and

a heat release material provided on the electrode lead between the through hole and the battery element.

(2)

The battery according to (1), where the heat release material has a thermal conductivity of 30 W/m²·K or more.

(3)

The battery according to (1) or (2), further including a film-shaped exterior material that houses the battery element such that one end of the electrode lead is exposed to the outside.

(4)

The battery according to (3), where the exterior material is a laminate film.

(5)

The battery according to (3) or (4), where the heat release material is provided outside the exterior material.

(6)

The battery according to any of (3) to (5), where the heat release material is provided within the exterior material.

(7)

The battery according to any of (3) to (6), where the through hole is provided outside the exterior material.

(8)

The battery according to any of (3) to (7), where the through hole is covered with the exterior material.

(9)

The battery according to any of (1) to (8), where the heat release material is provided so as to make direct contact with the electrode lead.

(10)

The battery according to any of (1) to (9), where the electrode lead is a positive electrode lead.

(11)

A battery pack including:

the battery according to any of (1) to (10); and

a control unit that controls the battery.

(12)

An electronic device including the battery according to any of (1) to (10), where the device receives power supply from the battery.

(13)

An electric vehicle including:

the battery according to any of (1) to (10);

a conversion device that receives power supply from the battery to convert the power to a driving force for the vehicle; and

a control device that performs information processing related to vehicle control, based on information on the battery.

(14)

An electric storage device including the battery according to any of (1) to (10), where the device supplies electric power to an electronic device connected to the battery.

(15)

A power system including the battery according to any of (1) to (10), where the system receives power supply from the battery.

### DESCRIPTION OF REFERENCE SYMBOLS

10: Battery
11: Battery element
12: Exterior material
13A: Positive electrode lead
13B: Negative electrode lead
13C: Through hole
16: Heat release material

1. A battery comprising:
a battery element comprising an electrode lead comprising at least one through hole; and
a heat release material provided on the electrode lead between the through hole and the battery element.

2. The battery according to claim 1, wherein the heat release material has a thermal conductivity of 30 W/m²·K or more.

3. The battery according to claim 1, further comprising a film-shaped exterior material that houses the battery element such that one end of the electrode lead is exposed to outside.

4. The battery according to claim 3, wherein the exterior material is a laminate film.

5. The battery according to claim 3, wherein the heat release material is provided outside the exterior material.

6. The battery according to claim 3, wherein the heat release material is provided within the exterior material.

7. The battery according to claim 3, wherein the through hole is provided outside the exterior material.

8. The battery according to claim 3, wherein the through hole is covered with the exterior material.

9. The battery according to claim 1, wherein the heat release material is provided so as to make direct contact with the electrode lead.

10. The battery according to claim 1, wherein the electrode lead is a positive electrode lead.

11. A battery pack comprising:
the battery according to claim 1; and
a control unit that controls the battery.

12. An electronic device comprising the battery according to claim 1, wherein the device receives power supply from the battery.

13. An electric vehicle comprising:
the battery according to claim 1;
a conversion device that receives power supply from the battery to convert the power to a driving force for the vehicle; and
a control device that performs information processing related to vehicle control, based on information on the battery.

14. An electric storage device comprising the battery according to claim 1, wherein the device supplies power to an electronic device connected to the battery.

15. A power system comprising the battery according to claim 1, wherein the system receives power supply from the battery.
